(19) United States
(12) Patent Application Publication
(10) Pub. No.: US 2025/0030007 A1
(43) Pub. Date: Jan. 23, 2025

(54) ELECTROCHEMICAL ENERGY STORAGE ELEMENT WITH A CONTACT SHEET METAL MEMBER AND METHOD OF MANUFACTURING THE SAME

(71) Applicant: VARTA Microbattery GmbH, Ellwangen Jagst (DE)

(72) Inventor: Martin Elmer, Ellwangen (DE)

(21) Appl. No.: 18/774,959

(22) Filed: Jul. 17, 2024

(30) Foreign Application Priority Data
Jul. 18, 2023 (EP) 23186253.3

(51) Int. Cl. H01M 4/75; H01M 4/02; H01M 10/0525; H01M 10/0587; H01M 50/46; H01M 50/533; H01M 50/536

(52) U.S. Cl. CPC H01M 4/75; H01M 10/0587; H01M 50/46; H01M 50/533; H01M 50/536; H01M 2004/021; H01M 10/0525

(57) ABSTRACT

An electrochemical energy storage element includes a housing and an electrode-separator assembly arranged inside the housing. The electrode-separator assembly includes a side that is delimited by a circumferential edge or multiple edges. The electrochemical energy storage element further includes a contact sheet metal member that rests on the side of the electrode-separator assembly and that is connected to the electrode-separator assembly in a region of the side by welding. The contact sheet metal member comprises at least one part that is bent in a direction of the electrode-separator assembly.

### CROSS REFERENCE TO RELATED APPLICATIONS

This application claims benefit to European Patent Application No. EP 23186253.3 filed on Jul. 18, 2023, which is hereby incorporated by reference herein.

### FIELD

The present disclosure relates to an electrochemical energy storage element having at least one contact sheet metal member that rests on an end face of an electrode-separator assembly and to a method of manufacturing such an electrochemical energy storage element.

### BACKGROUND

Electrochemical energy storage elements can convert stored chemical energy into electrical energy through virtue of a redox-reaction. They generally comprise at least one energy storage cell with a positive and a negative electrode, which are separated from each other by a separator. During a discharge, electrons are released at the negative electrode as a result of an oxidation process. This results in an electron current that can be drawn off by an external electrical consumer, for which the at least one electrochemical energy storage cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and thus recharge the cell, this is said to be a secondary cell. The common designation of the negative electrode as the anode and the designation of the positive electrode as the cathode in secondary cells refers to the discharge function of the electrochemical cell.

Lithium-ion cells are used for many applications today, as these cells can provide high currents and are characterized by a comparatively high energy density. They are based on the use of lithium, which can migrate back and forth between the electrodes of the cell in the form of ions.

The negative electrode and the positive electrode in energy storage elements are often formed by so-called composite electrodes, which comprise electrochemically inactive components as well as electrochemically active components. The composite electrodes are usually combined with one or more separators to form an electrode-separator assembly. The basic functionality of the cell can be established by impregnating the assembly with an electrolyte. Alternatively, a solid-state electrolyte can be used instead of a separator impregnated with an electrolyte.

In many embodiments of energy storage elements, the electrode-separator assembly is formed in the form of a winding or processed into a winding. It generally comprises the sequence positive electrode/separator/negative electrode. The assembly is often produced as a so-called bi-cell with the possible sequences negative electrode/separator/positive electrode/separator/negative electrode or positive electrode/separator/negative electrode/separator/positive electrode. In other embodiments, the electrode-separator assembly is formed by stacked electrodes with separators or solid electrolyte layers in between.

Energy storage elements comprising an electrode-separator assembly in the form of a winding often have a cylindrical design. A distinction is made between cylindrical round cells and button cells. Cylindrical round cells are generally characterized by the fact that their height is greater than their diameter. Button cells, on the other hand, have a height that is smaller than their diameter.

Some button cells are offered in very small designs. They are suitable, for example, for powering small electronic devices such as watches, hearing aids, wireless headphones or similar. They generally have a maximum diameter of <3 cm.

A common form factor for cylindrical round cells, for example, is 21×70 (diameter×height in mm). Modern lithium-ion cells of this form factor can achieve an energy density of up to 270 Wh/kg, for example.

The housing of energy storage elements that have an electrode-separator assembly of stacked electrodes is usually a prismatic housing and is characterized by a polygonal base, in particular a rectangular base. The stack generally comprises electrodes with a likewise polygonal, which are placed on top of each other in such a way that the electrode-separator assembly is also prismatic. Such a prismatic assembly can perfectly fill the interior space of a prismatic housing. Typically, all electrodes with the same polarity are coupled to a common current conductor, which either connects them electrically to a metallic housing part of the prismatic housing or is coupled to a pole that is led out of the housing through a corresponding aperture.

WO 2017/215900 A1 describes energy storage cells in which the electrodes are ribbon-shaped and the electrode-separator assembly is in the form of a winding. The electrodes each have current collectors loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on the opposite side. For electrical contacting of the current collectors, the cell has at least one contact sheet metal member which rests on one of the longitudinal edges on one end face of the electrode-separator assembly. The contact sheet metal member is connected to the longitudinal edge by welding. This makes it possible to electrically contact the current collector and thus also the associated electrode over its entire length. This significantly reduces the internal resistance within the cell described. As a result, the occurrence of large currents can be absorbed much better.

The housing of electrochemical energy storage elements is often made up of metallic components. For example, the housing can be formed from a cup-shaped metallic housing part and a metallic lid part. In these cases, the energy storage elements can be manufactured in such a way that the electrode-separator assembly in the form of the described winding or stack is inserted into the cup-shaped housing part before the housing is closed by means of the lid part, which is welded on, for example. These processes for manufacturing energy storage elements are generally carried out in an automated manner as part of industrial manufacturing processes.

In order to achieve the highest possible energy density of the energy storage element to be produced, attempts are generally made to incorporate as much electrochemically active material as possible into the energy storage element. An attempt is therefore made to maximize the housing volume available for the electrode-separator assembly by inserting the largest possible assemblies into housings. This can lead to problems, for example, when inserting a cylindrical winding into a cup-shaped housing part. If the electrode-separator assembly presses too hard against the inside of the housing during insertion, the insertion may fail or cause damage.

This problem can be further exacerbated by a contact sheet metal member welded onto the electrode-separator assembly, as described in WO 2017/215900 A1. This applies in particular if the contact sheet metal member is not positioned exactly on the respective end face of the electrode-separator assembly and protrudes beyond an edge of the end face. The exact, centered arrangement of such contact sheet metal members is not always easy in industrial manufacturing processes, as the circumference of the electrode-separator assembly can be subject to production-related fluctuations, so that this alone can lead to problems when placing and welding the contact sheet metal member on the end face.

In addition, if the contact sheet metal member is not positioned exactly, the electrode-separator assembly cannot be welded to the contact sheet metal member optimally or over the entire available area of the respective end face. For example, if the contact sheet metal member is not optimally positioned, the outer windings of a cylindrical electrode-separator assembly may not be able to make contact with the contact sheet metal member. This can elevate the internal resistance of an affected energy storage element.

Various procedures are already known that address known problems in connection with inserting an electrode-separator assembly into a housing. For example, U.S. Pat. No. 10,505,222 B2 proposes compressing the electrode-separator assembly before inserting it into a housing. EP 4053955 A1 relates to a method of manufacturing an energy storage element in which a metallic housing part is heated before an electrode-separator assembly is inserted. This causes the housing part to expand so that the electrode-separator assembly can be inserted into the housing part more easily. However, the smaller the housing part, the smaller the heating effect.

However, these approaches do not solve the problems described above in connection with a contact sheet metal member placed on the end face of an electrode-separator assembly.

### SUMMARY

In an embodiment, the present disclosure provides an electrochemical energy storage element including a housing and an electrode-separator assembly arranged inside the housing. The electrode-separator assembly includes a side that is delimited by a circumferential edge or multiple edges. The electrochemical energy storage element further includes a contact sheet metal member that rests on the side of the electrode-separator assembly and that is connected to the electrode-separator assembly in a region of the side by welding. The contact sheet metal member comprises at least one part that is bent in a direction of the electrode-separator assembly.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides a longitudinal sectional view through a schematic representation of a preferred embodiment of an energy storage element;

FIGS. 2A and 2B provide views of two preferred embodiments of contact sheet metal members;

FIGS. 3A and 3B provide views of two further preferred embodiments of contact sheet metal members;

FIG. 4 provides a schematic sectional view illustrating the connection of a contact sheet metal members to an electrode-separator assembly; and

FIG. 5 illustrates an electrode-separator assembly that can be installed, for example, in an energy storage element as shown in FIG. 1, as well as its components.

### DETAILED DESCRIPTION

Against this background, the present disclosure provides systems and methods for facilitating the exact placement of a contact sheet metal member on an end face of an electrode-separator assembly. Furthermore, the insertion of the electrode-separator assembly into the housing of the energy storage element is to be facilitated.

An electrochemical energy storage element according to an aspect of the present disclosure is characterized by the following features:
a. The electrochemical energy storage element comprises a housing.
b. An electrode-separator assembly is arranged inside the housing.
c. The electrode-separator assembly comprises one side which is delimited by a circumferential edge or multiple edges.
d. A contact sheet metal member rests on the side of the electrode-separator assembly which is delimited by the circumferential edge or the multiple edges, which is connected to the electrode-separator assembly in the region of the side by welding.

The energy storage element can further be characterized by the following feature:
e. The contact sheet metal member comprises at least one part which is bent in the direction of the electrode-separator assembly, in particular is bent over the edge delimiting the side or an edge delimiting the side.

Preferably, the at least part which is bent in the direction of the electrode-separator assembly, in particular over the edge delimiting the side, is at least one extension or, in an alternative designation, a protruding region which is extending from a main portion of the contact sheet metal member which rests on the side.

Preferably, the bent extension or bent protruding region encloses a bending angle in a range from 60° and 120° with the main portion of the contact sheet metal member. A bending angle in a range from 80° to 100° is preferred, in particular an angle in the range 90°±5° or exactly 90°.

Preferably, the energy storage element is characterized by at least one of the following features:
a. The electrode-separator assembly comprises at least one anode, at least one cathode and at least one separator with the sequence anode/separator/cathode.
b. The electrode-separator assembly comprises at least one anode, at least one cathode and at least one layer of a solid electrolyte with the sequence anode/solid electrolyte/cathode.
c. The housing in which the electrode-separator assembly is arranged is an airtight and liquid-tight sealed housing.
d. The electrode-separator assembly is electrically connected to a part of the housing or an electrical pole passing through the housing via the contact sheet metal member.

The energy storage element can have a prismatic housing or a cylindrical housing. In the case of a prismatic housing, the electrode-separator assembly preferably has an prismatic shape, too. In the case of a cylindrical housing, the electrode-separator assembly preferably has a cylindrical shape.

Accordingly, in a preferred embodiment, the energy storage element is characterized by at least one of the following features:
a. The electrode-separator assembly is formed by spirally wound electrode ribbons with at least one separator ribbon lying therebetween, and the electrode-separator assembly has a first and a second end face and a winding shell lying therebetween, one of the end faces being the side of the electrode-separator assembly which is delimited by the circumferential edge.
b. The electrode ribbons are formed by ribbon-shaped current collectors coated with electrode material.
c. At least one of the ribbon-shaped electrode current collectors has a longitudinal edge which is not coated with electrode material, the electrode ribbons being arranged within electrode-separator assembly such that the longitudinal edge which is not coated with electrode material protrudes from the end face of the electrode-separator assembly on which the contact sheet metal member rests.
d. The contact sheet metal member is welded to the longitudinal edge protruding from the end face.

Preferably, the aforementioned features a. to d. are realized in combination with each other.

In this embodiment, the energy storage element preferably comprises a cylindrical housing and a cylindrical electrode-separator assembly.

In typical cases, the spirally wound electrode ribbons and the at least one separator ribbon preferably have the following dimensions:
A length in a range from 0.5 m to 25 m
A width in a range from 40 mm to 145 mm

To produce a wound electrode-separator assembly consisting of electrode ribbons and at least one ribbon-shaped separator, the ribbon-shaped electrodes and the at least one separator are generally fed to a winding device, where they are preferably wound in a spiral around a winding axis. Bonding of the electrodes and the separators or contacting at elevated temperatures is usually not necessary. In some embodiments, the electrodes and the at least one separator are wound onto a cylindrical or hollow-cylindrical winding core, which is seated on a winding mandrel and remains in the winding after winding.

The winding shell can be formed by a plastic film or an adhesive tape, for example. It is also possible for the winding shell to be formed by one or more separator windings.

In a further preferred embodiment, the energy storage element is characterized by at least one of the following features:
a. The electrode-separator assembly is formed by stacked electrodes between which separators or layers of solid electrolyte are arranged.
b. The electrodes are formed by current collectors coated with electrode material.
c. The current collectors of the positive and/or the negative electrodes each have a current collector edge which is not coated with electrode material, the electrodes being arranged within the stack such that all current collector edges of the positive or of the negative electrodes which are not coated with electrode material protrude from one side of the electrode-separator assembly, this side being the side of the electrode-separator assembly on which the contact sheet metal member rests.
d. The contact sheet metal member is welded to the edges of the current collector protruding from this side.

Preferably, the aforementioned features a. to d. are realized in combination with each other.

In this embodiment, the energy storage element preferably has a prismatic housing and a prismatic electrode-separator assembly.

In the prismatic electrode-separator assembly, current collector edges of the positive and negative electrodes can also protrude from more than one side of the electrode-separator assembly. For example, it may be provided that positive electrodes with a rectangular base shape each have two uncoated current collector edges protruding from two adjacent sides of the electrode-separator assembly. In this case, the contact sheet metal member can be L-shaped, for example, and resting on both sides from which the uncoated longitudinal edges protrude.

In the case of the prismatic shape, the electrode-separator assembly preferably comprises a plurality of electrodes with a rectangular base shape. If, on the other hand, the electrode-separator assembly has the cylindrical shape, it preferably consists of ribbon-shaped electrodes and the at least one ribbon-shaped separator, which are wound in a spiral. The separator is preferably impregnated with a suitable electrolyte, as are the electrodes.

Furthermore, the electrode-separator assembly can also be formed as a flat coil with spirally wound ribbon-shaped electrodes and have an essentially prismatic shape.

The electrodes are preferably composite electrodes comprising electrochemically active components and electrochemically inactive components, which have already been mentioned in the introductory section.

The current collectors of the energy storage element have the function of electrically contacting electrochemically active components contained in the respective electrode material over as large an area as possible. Preferably, the current collectors consist of a metal or are at least metallized on the surface.

In the case of an energy storage element designed as a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are particularly suitable as nickel alloys. Alloys of the type NiFe, NiCu, CuNi, NiCr and NiCrFe are particularly suitable as nickel alloys. Stainless steel can also be considered, for example type 1.4303 or 1.4404 or type SUS304.

In the case of an energy storage element designed as a lithium-ion cell, aluminum or other electrically conductive materials, including aluminum alloys, are particularly suitable as the metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a metal foil with a thickness in a range from 4 μm to 30 μm.

However, in addition to foils, other substrates such as metallic or metallized nonwovens or open-pored metallic foams or expanded metals can also be used as current collectors.

The current collectors are preferably loaded with the respective electrode material on both sides.

The separators of an energy storage element are preferably formed from an electrically insulating plastic film. This preferably has pores so that it can be penetrated by the liquid electrolyte. The plastic film can consist of a polyolefin or a polyether ketone, for example. However, nonwovens and fabrics made of plastic materials or other electrically insulating fabrics can also be used as separators.

Separators with a thickness in a range from 5 to 50 m are preferred.

In particular in the case of the prismatic electrode-separator assembly, layers of the aforementioned solid electrolyte can also be used instead of separators. A solid electrolyte has an intrinsic ionic conductivity and does not need to be impregnated with a liquid electrolyte. The solid electrolyte can, for example, be a polymer solid electrolyte based on a polymer-conducting salt complex, which is present in a single phase without any liquid component. A polymer solid-state electrolyte can have polyacrylic acid (PAA), polyethylene glycol (PEG) or polymethyl methacrylate (PMMA) as the polymer matrix. It may comprise lithium conductive salts such as lithium bis-(trifluoromethane)sulfonylimide (LiTFSI), lithium hexafluorophosphate (LIPF₆) and lithium tetrafluoroborate (LIBF₄).

It is preferred that the longitudinal edges of the separator or the separators or the longitudinal edges of said layers of solid electrolyte form the side or sides of the electrode-separator assembly from which (in the case of the cylindrical electrode-separator assembly) the longitudinal edge not coated with electrode material or (in the case of the prismatic electrode-separator assembly of stacked electrodes) all the current collector edges of the positive or negative electrodes not coated with electrode material protrude from.

With regard to the electrochemistry, the energy storage element is not limited to a specific type. In preferred embodiments, the energy storage element is a lithium-ion cell or comprises a lithium-ion cell, since such cells can provide a particularly high energy density at a comparatively low weight.

In other embodiments, the energy storage element is a sodium ion cell or comprises a sodium ion cell, a potassium ion cell, a calcium ion cell, a magnesium ion cell or an aluminum ion cell. Among these variants, energy storage elements with sodium ion cell chemistry are preferred.

As is well known, lithium-ion cells are based on the use of lithium, which can migrate back and forth between the electrodes of an energy storage element in the form of ions.

In the context of the present disclosure, all materials that can absorb and release lithium ions can be considered as electrochemically active components (active materials) for lithium-ion cells. For example, carbon-based particles, such as graphitic carbon, are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

The active materials are generally the main component of a layer that is applied to the current collector. The current collector is an electrochemically inactive component of the energy storage element. Metallic foils are particularly suitable as current collectors. The current collector for the negative electrode (anode current collector) of a lithium-ion cell can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of said layer on the current collectors and often also ensures the adhesion of the layer to the current collectors. Common conductivity-enhancing additives are carbon black, fine graphite, carbon fibers, carbon nanotubes and metal powder.

Solutions of lithium salts such as lithium hexafluorophosphate (LiPF₆) in organic solvents (e.g. ethers and esters of carbonic acid) are particularly suitable as electrolytes for lithium-ion cells.

Sodium-ion cells are known to be based on the use of sodium, which can migrate back and forth between the electrodes of an energy storage element in the form of ions.

The following materials, for example, can be considered as electrochemically active components (active materials) for sodium-ion cells on the anode side:
Carbon, especially hard carbon (pure or with nitrogen and/or phosphorus doping) or soft carbon or graphene-based materials (e.g. with nitrogen doping); carbon nanotubes, graphite
Polyanions such as Na₂Ti₃O₇, Na₃Ti₂(PO₄)₃, TiP₂O₇, TiNb₂O₇, Na—Ti—(PO₄)₃, Na—V—(PO₄)₃
Transition metal oxides: V₂O₅, MnO₂, TiO₂, Nb₂O₅, Fe₂O₃, Na₂Ti₃O₇, NaCrTiO₄, Na₄Ti₅O₁₂

On the cathode side, for example, the following materials can be considered:
Polyanions: NaFePO₄ (Triphylit-Typ), Na₂Fe(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, Na₄(CoMnNi)₃(PO₄)₂P₂O₇, NaCoPO₄, Na₂CoPO₄F
Silicates: Na₂MnSiO₄, Na₂FeSiO₄
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, Na(NiFeCoMn)O₂, Na(NiMnCo)O₂

In addition, the electrodes of an energy storage element based on sodium ions also preferably contain one of the aforementioned electrode binders and/or a conductivity-improving or other additive.

In a sodium-ion energy storage cell, both the anode and the cathode current collector preferably consist of aluminum or an aluminum alloy.

Energy storage elements based on sodium-ion technology preferably have an electrolyte with at least one solvent and at least one conducting salt.

Organic carbonates, ethers, nitriles and mixtures thereof are particularly suitable as solvents.

Preferred lead salts are NaPF₆, sodium difluoro(oxalato)borate (NaBOB), NaBF₄, sodium bis(fluorosulfonyl)imid (NaFSI), sodium 2 trifluoromethyl-4,5-dicyanoimidazole (NaTDI), sodium bis(trifluoromethansulfonyl)imide (NaTFSI), NaAsF₆, NaBF₄, NaClO₄, NaB(C₂O₄)₂, NaP(C₆H₄O₂)₃; NaCF₃SO₃, sodium triflate (NaTf) and Et₄NBF₄.

In preferred embodiments, additives may be added to the electrolyte of sodium-ion cells. Examples of preferred additives, in particular for stabilization, are the following: Fluoroethylene carbonate (FEC), transdifluoroethylene carbonate (DFEC), ethylene sulfite (ES), vinylene carbonate (VC), bis(2,2,2-trifluoroethyl)ether (BTFE), sodium 2-trifluoromethyl-4,5-dicyanoimidazole (NaTDI), sodium bis(fluorosulfonyl)imide (NaFSI), aluminum chloride (AlCl₃), ethylene sulfate (DTD), sodium difluorophosphate (NaPO₂F₂), sodium difluoro(oxalato)borate (NaODFB), sodium difluorobisoxalatophosphate (NaDFOP) and tris(trimethylsilyl)borate (TMSB).

In preferred embodiments, the energy storage element is characterized by at least one of the following features:
a. The bent part of the contact sheet metal member, in particular the extension or protruding region protruding from a main portion of the contact sheet metal member, is located in the region of the outer circumference of the contact sheet metal member, in particular the outer circumference of the main portion of the contact sheet metal member.
b. The contact sheet metal member comprises at least two, preferably 2 to 100, preferably three or four parts, extensions or protruding regions, which are bent in the direction of the electrode-separator assembly, in particular over an edge of the side on which the contact sheet metal member rests.

The particular advantage of the energy storage element lies above all in that the bent part or the bent parts can significantly facilitate the precise placement and, if appropriate, centering of the contact sheet metal member on the end face of the electrode-separator assembly. This applies in particular if the contact sheet metal member has two or, preferably, three or more of the bent parts. The bent parts can force correct placement and ensure that incorrect placement is avoided. Even if the contact sheet metal member initially may not have been placed correctly on the end face of the electrode-separator assembly, it can be aligned on the end face of the electrode-separator assembly with the aid of the extensions or protruding regions such that it rests flat and centered on the end face of the electrode-separator assembly. This allows production-related fluctuations in the size and shape of the end face to be compensated for, so that no difficulties arise during the subsequent processing of the electrode-separator assembly provided with the contact sheet metal member. The exact positioning of the contact sheet metal member placed on the end face simplifies the subsequent insertion of the electrode-separator assembly into a cup-shaped housing part, for example. This makes it possible to maximize the diameter or generally the dimensions of the electrode-separator assembly, so that the energy density of the energy storage element can be elevated compared to conventional energy storage elements.

It is also conceivable that the at least one extension or protruding region is bent in more than one step. For example, it is possible to subject the extension or protruding region to a first bending process (pre-bending), which leads, for example, to a bending in the direction of the electrode-separator assembly with a bending angle of 30° to 55°, and in a further step to subject it to a second bending process, which leads, for example, to a bending in the direction of the electrode-separator assembly with a bending angle of 60° to 120°.

In a preferred embodiment, the pre-bending is performed before the contact sheet metal member is placed on the end face of the electrode-separator assembly, and the further bending is performed after the contact sheet metal member is placed on the end face of the electrode-separator assembly. The further bending can take place, for example, when the electrode-separator assembly is inserted into the aforementioned cup-shaped housing part by corresponding contact with the inside of the cup-shaped housing part during insertion.

It is possible for the contact sheet metal member to have two extensions or protruding regions where the bending processes have led to different bending results. For example, one extension or protruding region may be bent with a larger bending angle than another. This can occur, for example, if a contact sheet metal member is not placed exactly centered on one end face of an electrode-separator assembly. When inserting an electrode-separator assembly into a housing part, one extension can then be bent more than another.

The measures according to the present disclosure can also improve the scrap rate when forming a welded joint between the electrode-separator assembly and the contact sheet metal member.

The particular advantages of the measures according to the present disclosure are particularly useful for an energy storage element with a cylindrical electrode-separator assembly and a cylindrical housing, as the centering of the contact sheet metal member on the end face of a cylindrical electrode-separator assembly causes particular difficulties in the production process. Nevertheless, the advantages of the measures according to the present disclosure can also be used for an energy storage element with prismatic housing and prismatic electrode-separator assembly.

In preferred embodiments of the energy storage element, the contact sheet metal member is designed according to at least one of the following additional features:
a. The contact sheet metal member has said main portion from which the extension or protruding region is protruding or from which the extensions or protruding regions are protruding.
b. The main portion has at least one round or one straight outer edge from which the extension or protruding region or regions protrude or protrude.
c. The maximum extension length of the main portion of the contact sheet metal member is smaller than the maximum extension length of the side of the electrode-separator assembly on which the contact sheet metal member rests.

The shape and size of the main portion of the contact sheet metal member are suitably adapted to the shape and size of the side of the electrode-separator assembly on which the contact sheet metal member rests, as the latter should contact the edge of the current collector protruding from the side over its entire length, if possible. In the case of an electrode-separator assembly in the form of a cylindrical winding, the contact sheet metal member in preferred embodiments has, for example, a disk-shaped main portion with a circular outer edge, so that it corresponds to the shape of the end face to be covered. If the electrode-separator assembly is a prismatic winding or comprises, for example, a prismatic electrode stack and the side to be covered by the main portion has a polygonal base, it is preferred that the contact sheet metal member has a polygonal main portion.

Preferably, the outer edge of the main portion is a circumferential edge, preferably a circular circumferential edge in the case of cylindrical windings.

The maximum extension length of the main portion of the contact sheet metal member is defined as the greatest possible distance between two points on the outer edge of the main portion.

The maximum extension length of the side of the electrode-separator assembly on which the contact sheet metal member rests is defined as the greatest possible distance between two points on the edge or edges delimiting the side.

In preferred embodiments of the energy storage element, it is characterized by at least one of the following additional features with regard to the at least one bent part of the contact sheet metal member:
a. The at least one bent part has a rectangular shape or a strip shape;
b. The at least one bent part has a triangular shape;
c. The at least one bent part has a semicircular outline or comprises a rounded end, in particular an end with a semicircular outline.
d. The contact sheet metal member comprises several bent parts between which recesses, in particular notched recesses, are provided.
e. The contact sheet metal member comprises several bent parts between which notches are provided.
f. The contact sheet metal member comprises a plurality of bent portions, the bent portions protruding from the at least one outer edge of the main portion at regular intervals.

The bent part can have various shapes and configurations. A rectangular shape or a triangular shape according to the aforementioned features a. or b. is preferred.

If there are several bent parts, the bent parts are preferably distributed at equal intervals over the entire outer edge of the main portion. The bent parts can also lie next to each other. If the bent parts are directly adjacent to each other, notched recesses or embossed recesses may be provided between them in accordance with features d. or e. above.

Preferably, the at least one bent part, preferably the at least two bent parts, consist of the same material as the main portion. Theoretically, it would be possible to manufacture the parts separately and fix them to the main portion. However, it is much easier to manufacture the contact sheet metal member in one piece, including the extensions or protruding regions, for example as a stamped part. The stamping dies are then preferably designed such that the contact sheet metal members can be stamped out of a sheet, including the extensions, in a single operation. The bending is then preferably carried out afterwards, which will be referred to in more detail below.

With regard to the at least one extension or protruding region, the energy storage element is preferably characterized by the following additional feature:
a. The at least one extension or protruding region protrudes at least 0.1 and not more than 1 mm from the outer edge of the main portion.

Preferably, the at least one extension or protruding region protrudes at least 0.1 and at most 0.5 mm from the outer edge of the main portion.

The given preferred values preferably refer to a state of the contact sheet metal member in which the at least one extension or protruding region has not yet been bent.

With regard to the aforementioned advantages of the measures according to the present disclosure, even a very short length of the extensions or protruding regions of the contact sheet metal member, i.e. in particular a length in a region of less than 1 mm, is sufficient. In some preferred embodiments the length of the extensions can be selected such that, after bending, the extensions or protruding regions come into contact exclusively with the uncoated longitudinal edges of the current collector or current collectors to which the contact sheet metal member is welded. However, it is also possible for the length to be selected such that the extensions or protruding regions extend into the region of the current collectors coated with electrode material.

Preferably, a maximum projection of the at least one extension or protruding region, starting from the outer edge of the main portion, is smaller than a minimum distance of the main portion from the end face from which the longitudinal edge or edges protrude from.

In preferred embodiments of the energy storage element, the contact sheet metal member is characterized by the following additional feature:
a. The contact sheet metal member has a preferably uniform thickness in a range from 50 μm to 600 μm, in particular in a range from 100 μm to 500 μm, preferably 200 μm or 300 μm.

A thickness of the contact sheet metal member of 200 μm is particularly suitable for contacting the anode or the negative electrodes and a thickness of the contact sheet metal member of 300 μm is particularly suitable for contacting the cathode or the positive electrodes.

In preferred embodiments of the energy storage element, the contact sheet metal member is characterized by the following additional feature:
a. The contact sheet metal member has at least one bead, which is formed as an elongate depression on one flat side of the contact sheet metal member and as an elongate elevation on the opposite flat side, wherein the contact sheet metal member faces the electrode-separator assembly with the flat side carrying the elongate elevation.

Furthermore, in preferred embodiments, the energy storage element may be characterized by at least one of the following additional features:
a. The contact sheet metal member is welded to the electrode-separator assembly in the region of at least one bead.
b. The welds are linear.
c. The welds are formed by two or more parallel weld seams per bead.

Preferably, the aforementioned features a. and b. and, preferably, the aforementioned features a. to c. are realized in combination with one another.

Welding the contact sheet metal member to the electrode-separator assembly in the region of the at least one bead can further improve the stability of the weld and the welding contact with the electrodes in general.

Preferably, the contact sheet metal member has two or three or more beads.

It may be provided that the beads leave out a central region of the contact sheet metal member. In preferred embodiments, an aperture, for example in the form of a round hole, can be provided in this central region of the contact sheet metal member. This aperture in the contact sheet metal member can be used to fill in an electrolyte liquid.

In some embodiments, it has proven advantageous to subject the longitudinal edge of the respective current collector, which protrudes from the end face of the electrode-separator assembly, to a pretreatment before the contact sheet metal member is placed on top. In particular, at least one depression can be folded into the longitudinal edge, which corresponds to the at least one bead or the elongated elevation on the flat side of the contact sheet metal member facing the electrode-separator assembly.

The longitudinal edge of the current collector may also have been subjected to directional forming by pre-treatment. For example, it can be bent in a defined direction.

In preferred embodiments of the energy storage element, the contact sheet metal member is characterized by the following additional feature:
a. The contact sheet metal member has at least one extension or protruding region adjacent to the region of a bead.

This embodiment has the advantage that the extensions or protruding regions can be bent in a particularly simple manner. Since the bead forms a channel-shaped depression on the flat side of the contact sheet metal member that faces away from the electrode-separator assembly, the adjacent extension or protruding regions are also at a lower level than the other regions of the contact sheet metal member. This provides a target bending line for bending the extensions or protruding regions, making bending easier.

Preferably, the contact sheet metal member has at least one extension or protruding region that is configured as an extension to a bead.

The contact sheet metal member can be electrically connected to the anode current collector or to the cathode current collector of an energy storage element. As explained in WO 2017/215900 A1, the use of a contact sheet metal member has the advantage that the electrodes are in contact with the contact sheet metal member along their respective longitudinal edges. This can generally reduce the internal resistance of the energy storage element, so that the occurrence of larger currents can be absorbed much better in comparison with classic energy storage elements.

A contact sheet metal member provided for electrical connection to an anode current collector of the electrode-separator assembly, in particular in a lithium-ion cell, may be characterized by at least one of the following features:
a. The contact sheet metal member consists of nickel or copper or titanium or a nickel or copper or titanium alloy or stainless steel, for example of type 1.4303 or 1.4404 or of type SUS304, or of nickel-plated copper.
b. The contact sheet metal member and the anode current collector consist of the same material.

A contact sheet metal member provided for making electrical contact with the cathode current collector of the electrode-separator assembly, in particular in a lithium-ion cell, may preferably be characterized by at least one of the following features:
a. The contact sheet metal member consists of aluminum or an aluminum alloy.
b. The contact sheet metal member and the cathode current collector consist of the same material.

Suitable aluminum alloys for the contact sheet metal member include Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Furthermore, the contact sheet metal member may be characterized by at least one of the following features:
a. The contact sheet metal member has two opposing flat sides and extends essentially in only one dimension.
b. The contact sheet metal member is a disk or a polygonal plate.
c. The contact sheet metal member is dimensioned such that it covers at least 40% of the end face of the electrode-separator assembly on which it rests, preferably at least 50%, preferably at least 60%, preferably at least 70%, preferably at least 80%.

Preferably, the aforementioned features a. and b. or a. and c. or b. and c. or, preferably, the immediately aforementioned features a. to c., are realized in combination with one another.

Covering the end face of the electrode-separator assembly with the contact sheet metal member over as large an area as possible is advantageous for the thermal management of the energy storage element. The larger the cover, the easier it is to contact the longest possible sections of the respective electrodes. Heat formed in the electrode-separator assembly can thus be dissipated particularly well to the housing via the contact sheet metal member.

The housing is preferably formed from a cup-shaped metallic housing part and a lid part consisting at least partly of metal. The cup-shaped housing part can be formed in a deep-drawing process, for example. However, it is also possible to produce it by welding a bottom into a tubular housing part. The two housing parts can be connected via a seal that has electrically insulating properties and insulates the two housing parts from each other electrically. It is also possible to join the two housing parts together by welding. In this case, preferably a metallic pole insulated from the housing is led out through an aperture in the housing.

The electrical and thermal contact of the electrodes with the housing or at least one of the housing parts is made via the contact sheet metal member. The contact sheet metal member itself can, for example, be electrically connected to a housing part or the metal pole via a current conductor or direct welding.

The housing parts can consist of aluminum, an aluminum alloy or a steel sheet, for example a nickel-plated steel sheet. Suitable aluminum alloys for the cup-shaped metallic housing part are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

The present disclosure further provides a method of manufacturing the described electrochemical energy storage element comprising the following method steps:
a. An electrode-separator assembly (104) is provided having at least one side delimited by a circumferential edge or edges.
b. A contact sheet metal member (110) is placed on this side of the electrode-separator assembly, the contact sheet metal member having at least one extension or protruding region (120).
c. The at least one extension or protruding region (120) is bent in the direction of the electrode-separator assembly, in particular over the edge or edges delimiting the side.
d. Before or after the at least one extension or projecting region (120) is bent, the contact sheet metal member (130) is connected to the electrode-separator assembly in the region of the end face by welding.
e. A cup-shaped housing part (101) with an opening and a lid part (102) for the housing of the energy storage element are provided.
f. The electrode-separator assembly (104) with the contact sheet metal member (110) is inserted into the cup-shaped housing part (101).
g. The opening of the cup-shaped housing part (101) is closed with the lid part (102).
h. Before and/or after closing the opening of the cup-shaped housing part with the lid part, the electrodes of the electrode-separator assembly (104) are electrically contacted with parts of the housing and/or a pole bushing.

The functional parts used in the method have all already been explained in connection with the energy storage element. Reference is hereby made to the corresponding explanations.

In the method of manufacturing the energy storage elements, the contact sheet metal member in step a. is preferably first placed on the side of the electrode-separator assembly such that the at least one extension or protruding region of the contact sheet metal member protrudes beyond the edge or edges delimiting the side. In a further step, the at least one extension or protruding region is bent in the direction of the electrode-separator assembly, so that the contact sheet metal member grips around the side of the electrode-separator assembly on which it rests with the at least one bent extension or protruding region. Ideally, the at least one extension or protruding region is bent in such a way that it is at a 90° angle to the main portion of the contact sheet metal member. The insertion of the electrode-separator assembly with such a contact sheet metal member into the cup-shaped housing part is significantly easier compared to conventional methods.

The gripping also has the advantage that an outer current collector edge can no longer push past the contact sheet metal member.

Before or after bending, the contact sheet metal member can be welded to the current collector edge or edges that protrude from the side of the electrode-separator assembly on which the contact sheet metal member rests.

As an alternative to the aforementioned step c., according to which the at least one extension or protruding region is bent in the direction of the electrode-separator assembly, it is also possible to bend the at least one extension or protruding region before the contact sheet metal member is placed on the end face of the electrode-separator assembly.

Closing the cup-shaped housing part according to the aforementioned step g. with the lid part can be carried out in a manner known per se, for example by welding, in particular laser welding, or possibly by crimping or gluing.

An electrolyte can be added to the electrode-separator assembly before or after closing the opening of the cup-shaped housing part with the lid part. For this purpose, for example, an opening can be provided in the bottom of the cup-shaped housing part, through which the electrolyte is introduced into the interior of the housing. This activation opening can then be closed again with a washer or similar, or for example by gluing or welding.

In preferred embodiments of the method, the electrode-separator assembly with the contact sheet metal member is inserted into the cup-shaped housing part so far that the contact sheet metal member is in direct contact with its bottom. The cup-shaped housing part is often electrically coupled to the anode and thus has a negative polarity. The contact sheet metal member with the bent extensions acts as an insertion aid, making assembly easier. In a subsequent step, the bottom and the contact sheet metal member can be joined by welding.

The use of the contact sheet metal member on the cathode side can also be advantageous.

Due to an improved positioning and fixing of the contact sheet metal members on the respective end faces of the electrode-separator assemblies, it is possible for the welding (e.g. laser lines) to be guided to the outer region of the respective end face of the electrode-separator assembly, so that outer layers of the electrode-separator assembly can also be better connected.

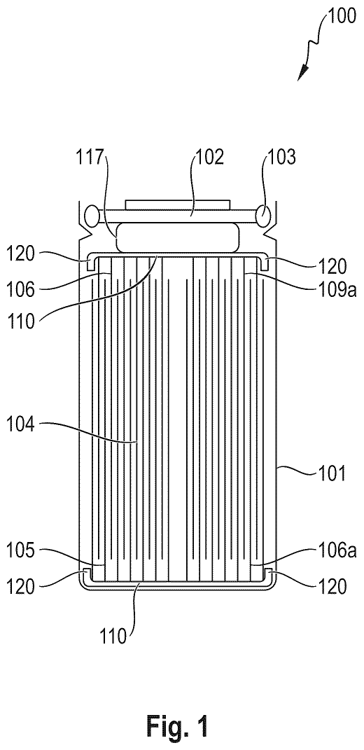

In an embodiment of an energy storage element shown in FIG. 1, the energy storage element 100 comprises a housing which is essentially formed by a cup-shaped housing part 101 and a lid part 102. The cup-shaped housing part 101 has a circular opening in the upper part of the embodiment, which is closed by the lid part 102. An electrically insulating seal 103 is provided between the opening edge of the cup-shaped housing part 101 and the lid part 102, which electrically insulates the housing parts 101 and 102 from each other and seals the housing.

Inside the housing is a wound electrode-separator assembly 104, which is a cylindrical winding of spirally wound ribbon-shaped electrodes and at least one ribbon-shaped separator. The electrodes are composite electrodes, each formed from a ribbon-shaped current collector coated with an electrode material. The electrode-separator assembly 104 has an upper end face facing the lid part 102 and a lower end face facing the bottom of the housing part 101. A free longitudinal edge 106a or 109a of the current collectors comprised by the electrodes, which is not coated with electrode material, protrudes from each of these. For example, the free longitudinal edge 106a of the anode current collector may protrude from the lower end face and the free longitudinal edge 109a of the cathode current collector may protrude from the upper end face of the electrode-separator assembly. The layers of electrode materials and the separator ribbons arranged between the electrodes are not shown in this illustration.

In the present embodiment, a contact sheet metal member 110 is provided on each of the two end faces of the electrode-separator assembly 104. In other embodiments, for example, a contact sheet metal member may be provided only on the upper end face or only on the lower end face.

The contact sheet metal members 110 are each electrically connected to the free longitudinal edges 106a or 109a of the current collectors protruding from the respective end face. The free longitudinal edges 106a or 109a of the current collectors are in direct contact with the respective contact sheet metal member 110 over their entire length and are connected thereto by welding.

The contact sheet metal member 110, which is welded to the free edge 106a of the anode current collector, rests directly on the bottom of the cup-shaped housing part 101 and is assembled thereto by welding. The contact sheet metal member 110, which is welded to the free edge 109a of the cathode current collector, is in electrical contact with the lid part 102 via an electrical conductor 117. Preferably, the electrical conductor 117 is connected both to the lid part 102 and to the bottom of the cup-shaped housing part 101 by welding.

Since the lid part 102 is electrically insulated from the cup-shaped housing part 101 by the insulating seal 103, the cup-shaped housing part 101 forms the negative pole and the lid part 102 forms the positive pole of the energy storage element 100.

The illustrated design of energy storage element 100 can be transferred in a comparable way to a cell with a prismatic housing and, for example, a flat winding or a stacked electrode-separator assembly.

The energy storage element 100 differs from conventional energy storage elements, which are provided with contact plates or contact sheet metal members, by the design of the contact sheet metal members 110. These are provided with a plurality of extensions 120, which are each bent in the direction of the electrode-separator assembly 104, so that the contact sheet metal members 120 embrace the two end faces of the electrode-separator assembly 104, on which they rest, with the bent extensions. In the shown embodiment, both contact sheet metal members 110 comprise bent extensions 120.

The bending of the extensions 120 takes place in the course of the manufacturing process of the energy storage element 100. Preferably the extensions 120 are pressed onto the respective end faces of the electrode-separator assembly 104 after the contact sheet metal members 110 have been placed on. The bending can take place before or after the contact sheet metal members 110 are welded to the longitudinal edges 106a and 109a of the current collectors.

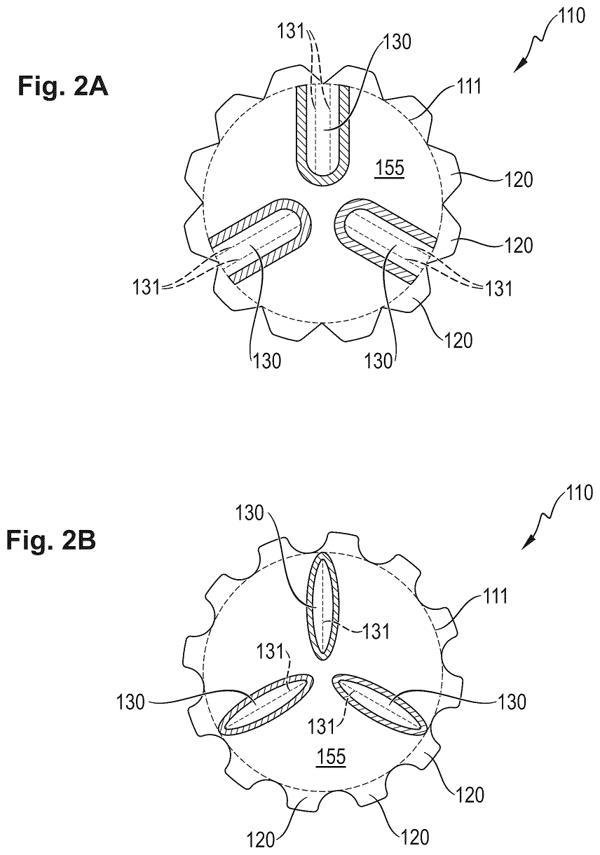

FIG. 2 shows in sub-figures A and B two exemplary embodiments of a contact sheet metal member 110. Both embodiments have a main portion 155 delimited by the circular outer edge 111, from which the extensions 120 protrude. Such contact sheet metal members 110 are suitable, for example, for placing on the end faces of the electrode-separator assembly shown in FIG. 1.

In these examples, the extensions 120 are each arranged along the entire outer edge 111 of the contact sheet metal member 110. In the example according to sub-figure A, notched recesses are provided between adjacent extensions 120. In the example according to sub-figure B, notches are provided between the individual extensions 120.

The contact sheet metal members 110 are stamped parts.

The contact sheet metal members 110 each have three beads 130 arranged in a star shape. On the flat side of the contact sheet metal member 110 which is provided for contacting the electrode-separator assembly, the beads 130 each appear as elevations. On the side of the contact sheet metal member 110 facing away from the electrode-separator assembly, the beads 130 each appear as elongated depressions. The beads 130 can be produced by an embossing process, for example.

Preferably, the contact sheet metal members 110 are welded to the respective free longitudinal edges of the current collectors in the regions of the beads 130, for example by one, two or more parallel weld seams 131 within the beads 130.

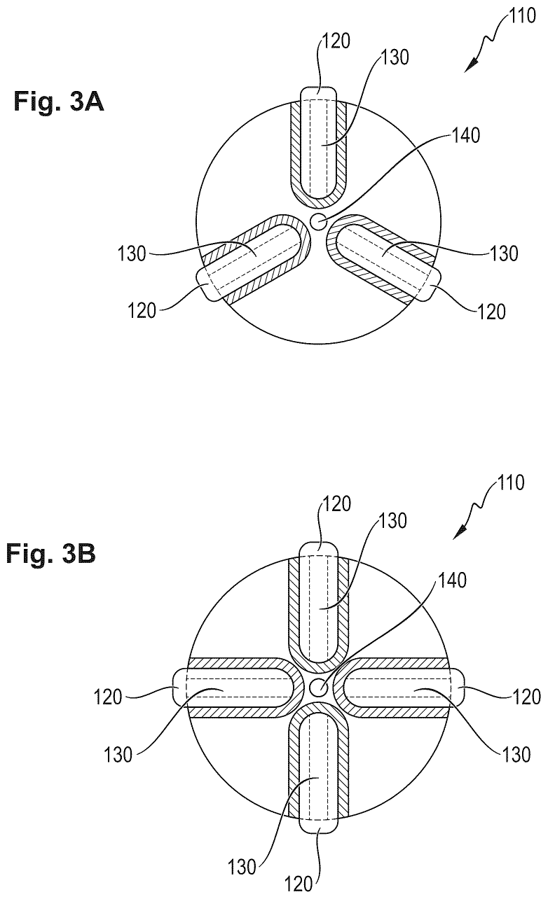

FIG. 3 shows in sub-figures A and B two further, preferred embodiments of contact sheet metal members 110. In sub-figure A, a contact sheet metal member 110 is shown with three extensions 120, each of which is an extension of one of the three star-shaped arranged beads 130. The embodiment of the contact sheet metal member 110 shown in sub-figure B is comparable, although in this example four beads 130 are provided, each of which encloses an angle of 90° with another one.

The configuration of the extensions 120 as extensions of the beads 130 has proven to be particularly advantageous in practice. The extensions lie on a lower level than the rest of the contact sheet metal member 120. This cab facilitate the bending of the extensions 120.

The embodiment of the contact sheet metal member 110 according to the partial figure B of FIG. 3 is preferred, since with this embodiment a particularly exact placement of the contact sheet metal member 110 on the respective end face of an electrode-separator assembly can be achieved.

The embodiments of the contact sheet metal member 110 shown in subfigures A and B of FIG. 3 each have a central aperture 140 in the form of a hole. This aperture 140 can be used to impregnate the electrode-separator assembly with an electrolyte after the contact sheet metal members 110 have been attached and welded.

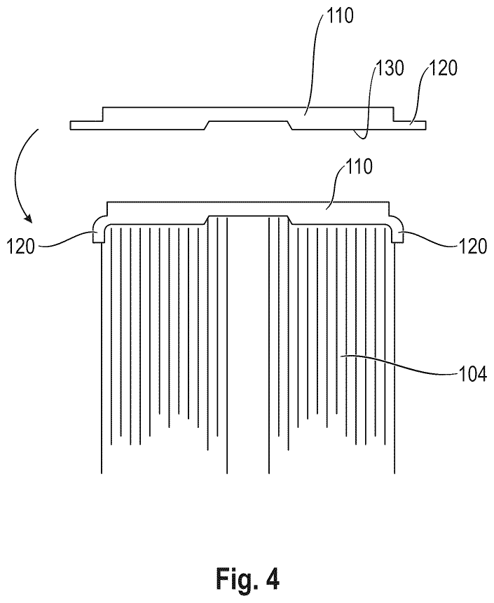

FIG. 4 shows a cross-section through a contact sheet metal member 110, in which, comparable to FIG. 3, the (not yet bent) extensions 120 are formed as extensions of the beads 130. The extensions 120 are located at a lower level than the remaining portion of the contact sheet metal member 110 outside the beads 130.

Further, an electrode-separator assembly 104 is shown, on one end face of which the contact sheet metal member 110 is placed. Preferably after the contact sheet metal member 110 has been placed on the end face of the electrode-separator assembly 104, the extensions 120 are bent downwards so that they are oriented in the direction of the electrode-separator assembly 104. The bent extensions 120 grip around the edge regions of the respective end face. On the one hand, this ensures the exact positioning of the contact sheet metal member 110 on the end face. On the other hand, this facilitates the insertion of the electrode-separator assembly 104 with the contact sheet metal member 110 into a cup-shaped or tubular housing part. The contact sheet metal member 110 acts as an insertion aid.

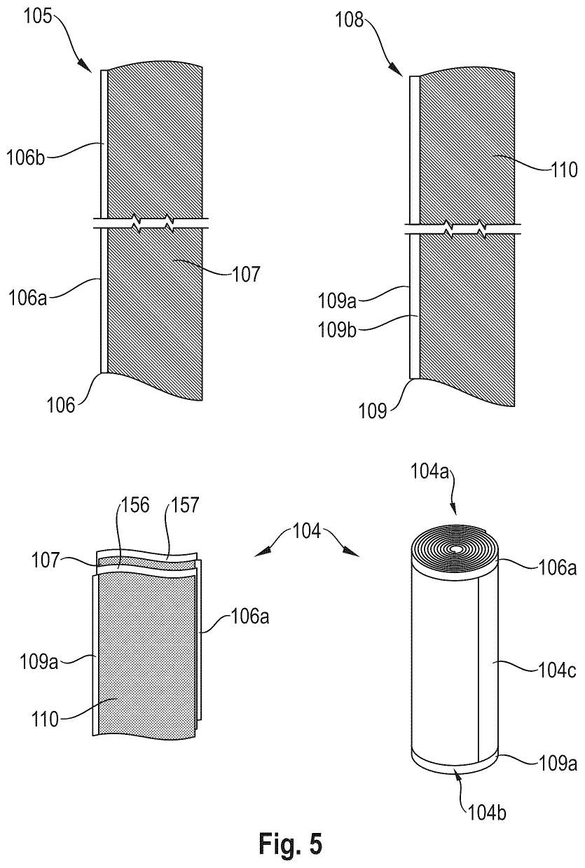

FIG. 5 illustrates the structure of an electrode-separator assembly 104, which can be a component of an energy storage element. The assembly 104 comprises the ribbon-shaped anode 105 with the ribbon-shaped anode current collector 106, which has a first longitudinal edge 106a and a second longitudinal edge parallel thereto. The anode current collector 106 is a foil made of copper or nickel. This comprises a strip-shaped main region, which is loaded with a layer of negative electrode material 107, and a free edge strip 106b, which extends along its first longitudinal edge 106a and which is not loaded with the electrode material 107. Further, the assembly 104 comprises the ribbon-shaped cathode 108 with the ribbon-shaped cathode current collector 109 having a first longitudinal edge 109a and a second longitudinal edge parallel thereto. The cathode current collector 109 is an aluminum foil. It comprises a strip-shaped main region, which is loaded with a layer of positive electrode material 110, and a free edge strip 109b, which extends along its first longitudinal edge 109a and which is not loaded with the electrode material 110. Both electrodes are shown individually in an unwound state.

The anode 105 and the cathode 108 are arranged offset from each other within the electrode-separator assembly 104, so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement can be seen in the illustration at the bottom left. The two ribbon-shaped separators 156 and 157, which separate the electrodes 105 and 108 from each other in the winding, are also shown there.

In the illustration at the bottom right, the electrode-separator assembly 104 is shown in wound form, as it can be used in an energy storage element according to FIG. 1. The electrode edges 106a and 109a protruding from the end faces 104a and 104b are clearly visible. The winding shell 104c is formed by a plastic film.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An electrochemical energy storage element, comprising:
a housing;
an electrode-separator assembly arranged inside the housing, the electrode-separator assembly comprising a side that is delimited by a circumferential edge or multiple edges; and
a contact sheet metal member that rests on the side of the electrode-separator assembly and is connected to the electrode-separator assembly in a region of the side by welding,
wherein the contact sheet metal member comprises at least one part that is bent in a direction of the electrode-separator assembly.

2. The electrochemical energy storage element according to claim 1, wherein the at least one part of the contact sheet metal member that is bent in the direction of the electrode-separator assembly is at least one extension or protruding region that protrudes from a main portion of the contact sheet metal member that rests on the end face.

3. The electrochemical energy storage element according claim 1, wherein at least one of:
the electrode-separator assembly is formed by spirally wound electrode ribbons with at least one separator ribbon lying therebetween, the electrode-separator further comprises a second end face and a winding shell lying between the end face and the second end face,
the electrode ribbons are formed by ribbon-shaped current collectors coated with electrode material,
at least one of the ribbon-shaped current collectors has a longitudinal edge that is not coated with electrode material, the electrode ribbons being arranged within the electrode-separator assembly such that the longitudinal edge not coated with electrode material protrudes from the end face of the electrode-separator assembly, and/or
the contact sheet metal member is welded to the longitudinal edge protruding from the end face.

4. The electrochemical energy storage element according to claim 1, wherein at least one of:
the electrode-separator assembly is formed by stacked electrodes between which separators or layers of a solid electrolyte are arranged;
the electrodes are formed by current collectors coated with electrode material;
the current collectors at least one of the electrodes each have a current collector edge that is not coated with electrode material, wherein the electrodes are arranged within the stack such that all current collector edges of the at least one electrode that are not coated with electrode material protrude from the first side of the electrode-separator, and/or
the contact sheet metal member is welded to the edges of the current collector protruding from the first side of the electrode-separator assembly.

5. The electrochemical energy storage element according to claim 1, wherein at least one of:
the at least one bent part of the contact sheet metal member is located in a region of the outer circumference of the contact sheet metal member, and/or
the contact sheet metal member comprises at least two parts, extensions or projecting regions that are bent in the direction of the electrode-separator assembly.

6. The electrochemical energy storage element of claim 5, comprising at least one of:
the contact sheet metal member has a main portion from which the extension or protruding region is protruding or from which the extensions or protruding regions are protruding,
the main portion has at least one round or one straight outer edge from which the extensions or projecting regions protrude, and/or
a maximum extension length of the main portion of the contact sheet metal member is smaller than a maximum extension length of the side of the electrode-separator assembly.

7. The electrochemical energy storage element of claim 1, wherein at least one of:
the at least one bent part has a rectangular shape or a strip shape,
the at least one bent part has a triangular shape,
the at least one bent part has a semicircular outline or comprises a rounded end,
the contact sheet metal member comprises a plurality of bent parts, between which recesses, are provided,
the contact sheet metal member comprises a plurality of bent parts between which notches are provided, and/or
the contact sheet metal member comprises a plurality of bent portions protruding from the at least one outer edge of the main portion at regular intervals.

8. The electrochemical energy storage element according to claim 2, wherein the at least one extension or protruding region protrudes in a range of 0.1 to 1 mm from the outer edge of the main portion.

9. The electrochemical energy storage element according to claim 1, wherein the contact sheet metal member has a thickness in a range of 50 μm to 600 μm.

10. The electrochemical energy storage element according to claim 1, wherein the contact sheet metal member has at least one bead formed as an elongate depression on one flat side of the contact sheet metal member and an elongate elevation on an opposite flat side, and wherein the contact sheet metal member faces the electrode-separator assembly with the flat side that carries the elongate elevation.

11. The electrochemical energy storage element according to claim 10, wherein at least one of:
the contact sheet metal member is welded to the electrode-separator assembly in a region of the at least one bead,
welds between the contact sheet metal member and the electrode-separator assembly and linear welds, and/or
the welds between the contact sheet metal member and the electrode-separator assembly are formed by two parallel weld seams per bead.

12. The electrochemical energy storage element according to claim 10, wherein the contact sheet metal member has at least one extension or protruding region adjacent to the region of the at least one bead.

13. A method of manufacturing an electrochemical energy storage element according to claim 1, the method comprising:
providing the electrode-separator assembly having the side delimited by the circumferential edge or multiple edges;
placing the contact sheet metal member on the side of the electrode-separator assembly, the contact sheet metal member having the at least one extension or protruding region;
bending the at least one extension or protruding region in the direction of the electrode-separator assembly;
before or after bending the at least one extension or projecting region, connecting the contact sheet metal member to the electrode-separator assembly in the region of the side by welding;
providing a cup-shaped housing part with an opening and a lid part for the housing of the energy storage element;
inserting the electrode-separator assembly with the contact sheet metal member into the cup-shaped housing part;
closing the opening of the cup-shaped housing part with the lid part; and
before and/or after closing the opening of the cup-shaped housing part with the lid part, electrically contacting electrodes of the electrode-separator assembly to parts of the housing and/or a pole bushing.

14. The method according to claim 13, further comprising before or after closing the opening of the cup-shaped housing part with the lid part, adding an electrolyte to the electrode-separator assembly.

15. The electrochemical energy storage element according to claim 1, wherein the at least one part of the contact sheet metal member is bent over the edge delimiting the side of the electrode-separator assembly or is bent over one of the multiple edges delimiting the side of the electrode-separator assembly.
